(19) United States
(12) Patent Application Publication
(10) Pub. No.: US 2012/0179860 A1
(43) Pub. Date: Jul. 12, 2012

(54) SUSPENSION OF MEMORY OPERATIONS FOR REDUCED READ LATENCY IN MEMORY ARRAYS

(76) Inventors: Francesco Falanga, Pozzuoli (IT); Antonino Pollio, Vico Equense (IT); Antonio Mauro, Pozzuoli (IT); Massimo Iaculo, San Marco Evangelista (IT); Danilo Caraccio, Buonalbergo (IT)

(21) Appl. No.: 13/377,495

(22) PCT Filed: Jun. 10, 2009
(86) PCT No.: PCT/IT2009/000253

§ 371 Date: Apr. 3, 2012

(51) Int. Cl. G06F 12/02; G06F 12/00

(52) U.S. Cl. 711/103; 711/155; 711/E12.001; 711/E12.008

(57) ABSTRACT

Read latencies in a memory array can be reduced by suspending write operations. In one example, a process includes, writing a first data set into a memory, interrupting a second memory write operation, and reading the first data set from the memory after interrupting the second memory write operation.

### BACKGROUND

Currently the most common interface for both external and embedded flash memory is MultiMediaCard (MMC) and the corresponding embedded MMC (e-MMC). New standards such as Universal Flash Storage (UFS) also are being developed to allow internal and external flash memory to share a single bus. These standards are intended also to be adapted to other types of memory including magnetic, optical, and phase change.

In order to simplify an MMC or e-MMC interface, a memory card controller adapts the physical memory interface (such as a NAND interface) to the MMC bus interface and also manages tasks specific to the physical memory technology. For NAND memory, these tasks can include defragmentation, bad blocks management, error correction and detection, wear leveling algorithms, safe management, and logical to physical block remapping. This reduces the complexity of the rest of the system, but these additional memory controller tasks all require some time to execute, which can make the memory temporarily unavailable.

It can occur that, the memory card controller will take more than hundreds of milliseconds to execute a host command due to a currently running data management routine, such as data defragmentation or garbage collection, for example. During this time, the card will be in a busy state and it can manage no other host command until the end of the previous host command. As a result, the response to the read command is delayed. This increased latency can interfere with proper operation of the host.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a portion of a state diagram of an e-MMC flash memory card controller suitable for illustrating aspects of an embodiment;

FIG. 2 shows a portion of a state diagram for a memory controller in accordance with an embodiment;

FIG. 3 is a timing diagram of suspending and resuming a write operation in accordance with an embodiment;

FIG. 4 is a timing diagram of aborting a write operation in accordance with an embodiment;

FIG. 5 is a process flow diagram of suspending and resuming a write operation in accordance with an embodiment;

FIG. 6 is a process flow diagram of aborting a write operation in accordance with an embodiment;

FIG. 7 is a block diagram of a managed memory with a host interface capable of implementing the processes and apparatus described in the context of the other figures; and

FIG. 8 is a block diagram of a mobile device capable of implementing the processes and apparatus described in the context of the other figures.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

For PoD and many other demanding strategies and applications to work, the memory must provide sufficiently fast read operations and the read operations must be available very soon after the same data has been written. Accordingly, as described below, hosts can access a managed memory, regardless of the memory controller's state. If, for example, a write operation is in progress, the host can suspend the current write operation, execute a read operation and then resume the suspended write.

Such a suspend operation can be useful, for example, when the host has its own firmware stored onto the managed memory and it needs to load pieces of it at run time, while the memory controller is busy storing data. In one example, new command sequences allow the host to suspend and resume a long write operation in order to execute a quick read operation.

A Write Suspend command, followed by a Write Resume command can be used to guarantee to the host a read access time of a few milliseconds even in the worst conditions. This allows the host to implement a Page on Demand strategy, for example, by briefly freezing a write operation. Any other long memory management operation can be frozen in the same way.

The description below is presented in the context of the e-MMC 4.4 JEDEC (Joint Electron Device Engineering Council) JESD84-A44 Standard Specification (promulgated in association with the Electronic Industries Alliance), in order to simplify the explanation, but the same concepts can be transferred to other memory management protocols and memory interfaces.

A NAND flash memory whether embedded or in a separate removable card can easily meet typical read speed requirements for any system. Memory management and write algorithms, however, can introduce larger latencies. The memory management is assigned by the e-MMC specification to the memory card controller, so the host is unaware whether any particular process is being performed. Accordingly, to consistently provide high speed memory performance, there must be some way to accommodate memory management tasks.

When the e-MMC is a managed NAND flash memory card, the internal memory card controller is in charge of executing all of the internal NAND memory management operations. Of these defragmentation and garbage collection tend to be unpredictable and time consuming. These algorithms are usually executed during a write/erase command and their duration depends on the state of occupation of the NAND Flash Blocks and therefore on how the external host application accesses the memory system. For other types of physical memory there are other memory management operations that can interfere with a quick read cycle.

The execution of any management algorithms can increase the execution time of a write command in an unpredictable way. As a result a subsequent high priority read operation may be delayed longer than allowed by the specification. This can disrupt the operation of the host, among other things.

The present description is presented in the context of a flash memory card coupled through an e-MMC interface to a host, such a computer, smartphone, media player or similar device. However, the invention is not so limited. Many types of memory require background management tasks. Regardless of whether these tasks are similar to or very different from those required for flash memory, the present invention allows latencies from these tasks to be reduced. The present invention is not limited to a specific memory hardware configuration. The memory may be on a distinct card, a distinct chip or it may be embedded in some other device. The memory management operations can be performed by a memory card controller in the event that the memory is packaged as a memory card, however, the controller responsible for memory management may have a different name in other types of memory. Accordingly, the invention will be described in the context of a memory or managed memory with a memory controller coupled between the memory and the host.

Embodiments of the present invention may be more easily understood in the context of a simple example. In this example, a host system has addressed a write multiple blocks command to a memory controller. The example managed memory has an array of memory cells, grouped into blocks. The memory controller is in the middle of a data defragmentation operation on the coupled managed memory array or even just a portion of the memory. In a conventional flash memory card, the memory card controller will receive the data in a buffer and then go back to the defragmentation operation. This operation will then be followed by writing the new data. The host will not be able to send any more data or read any data until these operations are finished. In addition, the data just sent will not be available to be read until after the defragmentation process is over. Defragmentation is used as an example here. There are several other processes performed by the memory controller that can render the memory temporarily unavailable.

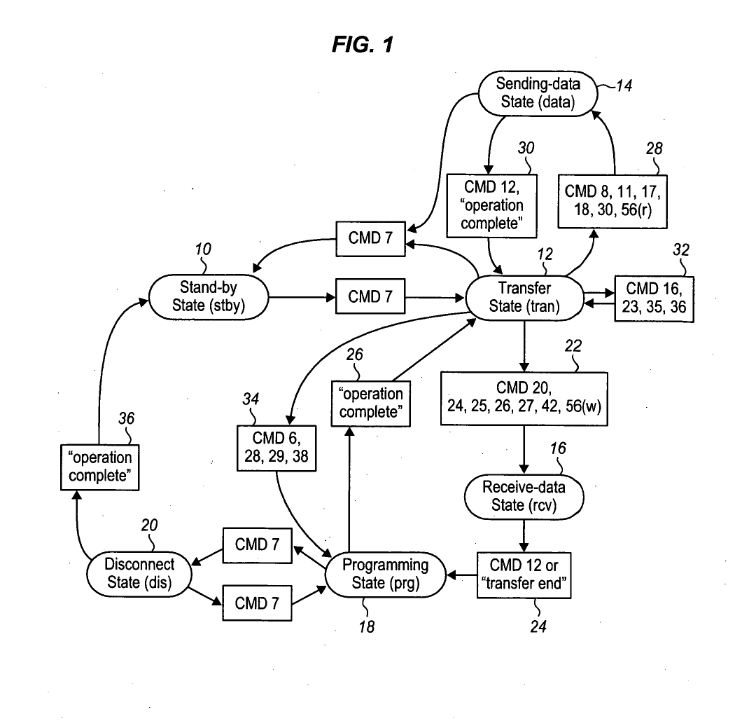

This example can be understood more fully in the context of the conventional state diagram for e-MMC provided in the Standard Specification. This state diagram has been reproduced as FIG. 1. Some of the detail has been removed from the standards diagram that are not relevant to the operations discussed herein. .

As shown in FIG. 1, the memory controller has several states. These include a Stand-by State (stby) 10, a Transfer State (tran) 12, a Sending-data State (data) 14, a Receive-data State (rcv) 16, a Programming State (prg) 18, and a Disconnect State (dis) 20. Other states are also defined but are not shown in order to simplify the diagram. For flash memory, writing to the memory cells for non-volatile storage is referred to as programming. For other types of memory, the Programming State might have a different name, such as write, or store. The particular states shown here are taken directly from the e-MMC Standard and are particularly well-adapted for NAND flash. However, the invention can be adapted to other types of memory and other types of state machines.

The controller transitions from one state to another based on receiving or generating a command, or in a few cases upon the occurrence of an “operation complete” event. The commands are all defined numerically as CMDxx, where xx is the number. Each command has the numerical definition and an argument. However, for many commands the argument is a stuff argument, meaning that it is not used to convey any information.

The transitions between stby and tran are controlled by the host using CMD7, a select/deselect command. Similarly the transitions between prg and dis and from data to stby are controlled by CMD7. The effect of the command depends upon the current state of the memory controller when the command is received. The transition from dis to stby occurs when the operation is complete.

In the simple example above, the host has addressed a write multiple blocks command to the memory card. This is CMD25. As shown in FIG. 1, CMD 25 can be received by the host controller in tran 12. In this example, the controller is in tran and after receiving the write command (CMD 25) at block 22, the memory controller state moves from tan to rcv to receive the data. After receiving all the data from the host to store (“transfer end”) or upon receiving a stop command (CMD12) at block 24, the memory controller state moves towards prg. According to the Standard Specification, the memory controller comes back to tran from prg, only if the previous write command has been completed (“operation complete” block 26). The host cannot send any other command to the memory controller while it is busy. If the controller is performing a complex operation such as a defragmentation, the controller may remain in the “Programming State” for several milliseconds.

A variety of different read requests are described by the standard. These are shown at block 28 as CMD8, 11, 17, 18, 30, 56(r). These commands can only be acted upon while the memory controller is in the Transfer State. Accordingly, to quickly service a read request the memory controller must move quickly from its current state to the Transfer State. From the Standby State, this can easily be done with CMD7. From the Sending-Data State, the memory controller is ready to send more data as soon as the current request has been complied with. From the. Disconnect State, the host can wait until the operation is completed at block 36 and then issue CMD7 to the Standby State or can command the memory controller to the Programming State with CMD7. The Programming State will transition with an operation complete at block 26 back to the Transfer State. In order to allow a read request to be served quickly from the Receive-Data state or the Program state, a fast “Out of Busy” method can be provided to the host. Such a method can provide the host with a means to freeze the current defragmentation, garbage collection, or other operation in progress on the e-MMC, freeing the memory controller to execute a higher priority read operation. The frozen operation can then be resumed later. As mentioned above, the memory management operation is frequently triggered by a write multiple blocks command (CMD25).

In brief, a write suspend command can be used to suspend any micro activity, releasing the DAT0 line (busy signal) and quickly making it possible to read from the device. A write resume command can then move the memory controller into a program state to complete the previously suspended write operation. A small amount of data can be saved to allow the micro activity to resume and complete the write operation later. After a write suspend, all those data blocks already entered into the device from the host side can be saved for later resuming. There are several different ways to provide an “Out of Busy” or “Suspend and Resume” method.

In one example the standard stop command (CMD12) is used with a unique argument, for example 0xF0F0F0F0 (in hexadecimal numbers). The standard stop command is always sent with a stuff argument and commands a standard STOP_TRANSMISSION. By changing the argument to a specific unique argument, the command's operation and functions can be changed. This new command can be considered to be a “Write Suspend” command.

According to this example, after receiving the Write Suspend command, the controller moves into prg 18 and, then, into “operation complete” 26 as soon as possible without completing all the steps. Instead, all the controller background write operations are suspended. The controller can be configured to hold or save all the information and data that it needs to resume and complete the write operation later on.

After “operation complete”, the memory controller is back into tran 12. From this state, the host can send a read command 28 to the managed memory and the memory controller will then transition to data 14 and serve that command. The read operation occurs in the data state 14. After the read operation reaches “operation complete” at block 30, then the memory controller returns to tran state 12 from which it can resume the previous write command by transitioning through rcv 16 to prg 18.

If the previous write command is not resumed, then all the data sent to the host in the previous write command will be lost. Any sequence of commands, apart from a resume sequence, can permanently stop the previous write command. To resume the write operation and transition from tran to prg, a variety of different approaches can be used. In one example, the following command sequence can be issued by the host:
CMD 16 (0x00000004)
CMD 56 (0x00000000)
write 4 Byte 0xF0F0F0F0

The Set Block Length command CMD 16 at block 32 is sent with argument “0x00000004”. The argument indicates the data transfer length of the next command CMD 56. This is followed by a generic write command (CMD56) at block 22 which takes the memory controller to the rcv state. The argument “0x00000000” is stuff bits except for the first bit (bit 0) which indicates the direction of the data transfer, in this case, towards the memory array. After the data is received, “transfer end” will send the memory controller to the prg state to write the block of data. Once it has entered this state, then the memory controller will complete the previously suspended write operation.

In another example, a new command can be used or an existing command can be given an additional purpose to send the memory controller directly into the “Programming” state. As shown at block 34, CMD6, 28, 29, 38 takes the memory controller from tran directly to prg. These commands can be used with consideration given to their special purposes. In either event, the command can be used to send the device directly into prg state to complete the previously suspended write operation. In the present example, CMD22 is used. This command does not currently have an assigned use in the e-MMC Standard Specification. Any other reserved or unused command can be used instead of CMD22 or to accommodate variations in the desired process.

With the write suspend or out of busy approaches described above, after issuing a suspend, if the host sends a read or resume command, then the maintenance operation can be resumed. However, if another command is issued then the memory controller may dismiss all of the resume information. This leaves the interrupted write command incomplete. Another risk is that if a suspend operation is in progress and then another read command is issued to addresses involved in the suspended write, the retrieved data could be undefined. In a third example, a write abort command sequence can be used. An abort command can be used to cause an abrupt interruption of all of the on-going memory maintenance operations initiated by the e-MMC controller during a write command. The interruption lets the host issue a high priority read command that can be executed quickly.

In response to a write abort command all the data re-copy operations in the memory can be discarded. If so, for a NAND memory, the physical blocks involved will be considered invalidated. Accordingly, the involved physical blocks of memory will be pre-erased again before writing into them for new data write operations. In order to avoid losing all of the data involved in the re-copy operations, the write command that was interrupted by the write abort command can then re-issued by the host. This allows the prior write operations to be completed after the high priority read.

When a write operation is aborted before completion, the memory controller can issue an error signal to indicate the operation was not successfully completed. In response to this, the host can then re-issue the corresponding write command. If the abort command is issued by the host as in the example described above, then the host can be configured to automatically repeat the last write request. In such a case, no error signaling is needed from the memory controller because the host is aware that the write operation was stopped.

As an alternative, the write abort command can be issued by the memory controller in response to a high priority read request from the host. In order to recover the aborted write operation, the memory controller can remember the aborted operation and automatically resume when the read request has been serviced. Alternatively, the memory controller can simple issue an error signal for the aborted operation. The error signal can then cause the host to reissue the last write operation.

The Abort command can be implemented in a variety of different ways. In one example, as with the first example, a STOP command (CMD 12) can be used modified by using a new argument format such as “0xF0F0F0F0”. Since the STOP command's arguments is made up entirely of stuff bits, other arguments can be used to add additional functions to the command.

The approaches described above can be implemented in the memory controller or the host. If the host is to be involved with write suspend or write abort operations, then the memory controller can indicate to the host whether it is able to support such commands and how. In the e-MMC Standard, each MMC card includes an EXT_CSD (extended card specific data) register. This register contains information about the card's capabilities and selected modes. The information includes start addresses, memory capacity, partitions, boot codes, enabled command sets, timing and speed specifications, erase protection modes, etc. The register on the card is read by the host, when the card is booted. In one example, a dedicated field in the Properties area of the Extended CSD Register can be set to communicate to a host platform that a Write Suspend/Resume or a Write Abort command, or both are available on the device. The Segment area of the Extended CSD register can be used for example to allow the host to choose whether to enable these commands. In one example, a byte can be present in the Segment area as set by the host. When the host sets the byte, then the Abort and Suspend/Resume functionalities on the device are enabled.

The bytes in the Segment area can have a structure as shown in Table 1, as an example.

TABLE 1

| | | Size | Cell | EXT_CSD |
|---|---|---|---|---|
| Name | Field | (bytes) [symbol] | Type [symbol] | slice [symbol] |
| Write pre-emption | WRITE_PRE_EMPTION_SUPPORT [symbol] | 1 [symbol] | R [symbol] | 503 [symbol] |
| support [symbol] | | | | |
| Write pre-emption | WRITE_PRE_EMPTION_MGMT [symbol] | 1 [symbol] | R/W/ | 161 [symbol] |
| management [symbol] | | | E [symbol] | |

The WRITE_PRE_EMPTION_SUPPORT field can have a structure as shown in Table 2, as an example.

TABLE 2

| | |
|---|---|
| Bit 7 | reserved |
| Bit 6 | reserved |
| Bit 5 | reserved |
| Bit 4 | reserved |
| Bit 3 | reserved |
| Bit 2 | reserved |
| Bit 1 | WRITE_PRE_EMPTION_ABORT_EN |
| Bit 0 | WRITE_PRE_EMPTION_RESUME_EN |

For Bit 1—WRITE_PRE_EMPTION_RESUME_EN, two different values can be used to indicate whether write pre-emption resume commands are enabled. In one example these values can be selected as:

0b0—Write Suspend/Resume command not supported; and

0b1—Write Suspend/Resume command supported.

Similarly, for Bit 0—WRITE_PRE_EMPTION_ABORT_EN, two different values can be used to indicate whether write pre-emption abort commands are enabled. In one example these values can be selected as:

0b0—Write Abort command not supported; and

0b1—Write Abort commands supported.

In a similar way the WRITE_PRE_EMPTION_MGMT field can have a structure as shown in Table 3, as an example.

TABLE 3

| | |
|---|---|
| Bit 7 | reserved |
| Bit 6 | reserved |
| Bit 5 | reserved |
| Bit 4 | reserved |
| Bit 3 | reserved |
| Bit 2 | reserved |
| Bit 1 | reserved |
| Bit 0 | WRITE_PRE_EMPTION_ACT |

Bit 0—WRITE_PRE_EMPTION_ACT can also have two different values to indicate whether write-pre-emption actions are supported. These values can be:

0b0—Write Abort command not activated by the host; and

0b1—Write Abort commands activated by the host.

The EXT CSD register of the e-MMC Standard provides a convenient way to communicate capabilities to a host and the tables above provide specific examples of how that might be done. However, other registers and other control mechanisms can be used to perform the same communication functions. For other types of memory devices and memory protocols, similar or different approaches can be used. Alternatively, the use of particular commands can be accepted by the host and card without any type of configuration or specific data or registers being used.

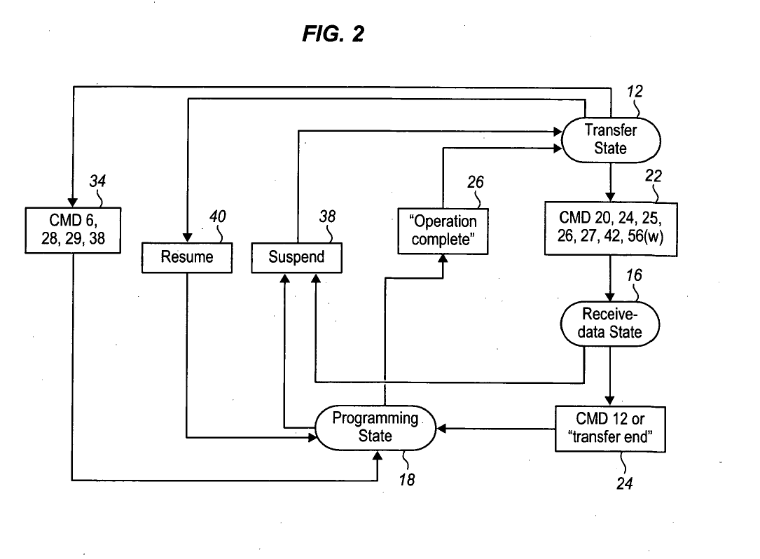

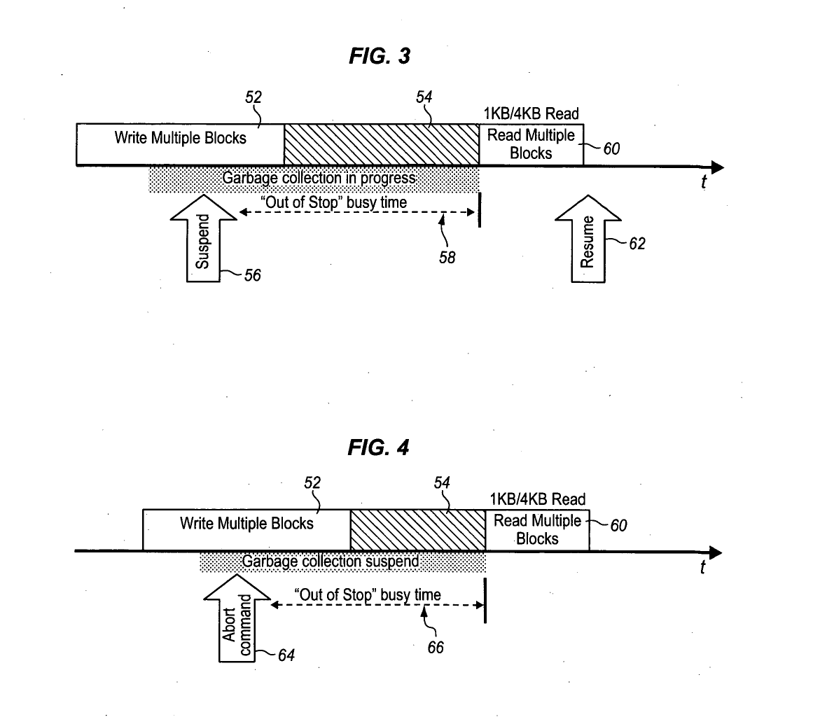

FIG. 2 is a simplified state diagram showing how suspend and resume operations can be added to the operation of a memory system. FIG. 2 includes the Transfer State 12, Receive-data State 16, and Programming State 18 of FIG. 1. The other states and their transitions are not shown in order to simplify the diagram. As in FIG. 1, the memory controller can transition from the Transfer State to Receive-data upon receiving commands at block 22. after the data is received at block 24, it transitions to the Programming state to write the data into memory. Upon completion of the write operation at block 26, it returns to the Transfer State. The other operations and commands also operate as describe in the context of FIG. 1. When the memory controller is in the Program State and a read command must be serviced quickly, FIG. 2 allows for a Suspend command to be received at block 38. This command can also be used to interrupt a Receive data State 16. The Suspend command transitions the memory controller quickly back to the Transfer State from which it can service the read request (not shown). From this State a resume command can be received at block 40, returning the memory controller to the Progamming State to finish the operation that was suspended. FIG. 3 is s transaction timing diagram for a suspend/resume approach such as that of FIG. 2. In FIG. 3 there is a horizontal time scale that moves from left to right. At the left end of the scale, the memory controller is writing multiple blocks 52. At the same time, a garbage collection or other memory maintenance task 54 is being executed. These tasks are typically performed in the Programming State 18 in a NAND flash memory card.

At some time during the write, a suspend command 56 is received. This commands the memory controller to stop the write operations in order to service a high priority read command. The suspend command is followed by an out of stop busy time 58. This is the time required to end the write operations, save the state and any necessary operands and data values, and transition to the data state 14. At the end of this busy time, the read command is serviced 60. After the high priority read command is serviced, a resume command 62 is issued that allows the memory controller to return to the write operations, including the garbage collection that was suspended (not shown).

FIG. 4 shows an alternative in which an abort command 64 is issued instead of a suspend command. In the example of FIG. 4, the memory controller is writing 52 and performing garbage collection 54, when an abort command is received. There is a corresponding busy time 66, and then the read is performed 60. In this case, the read is serviced more quickly because the busy time is shorter. This is because the abort command is not followed by a resume command. As a result, the memory controller is not required to remember anything about the write operations. The write operations will begin again from the start upon receiving another write command. As an alternative a stop command, or any other command that achieves a similar result can be used.

The suspend/resume commands cause less disruption to the system and require less attention from the host. The stop or abort command allow the read to be serviced more quickly, but any changes made during the write operation are lost and must be started over. A variety of other variations can be made to the approaches described above and the particular choice will depend upon the nature of the memory, its controller and the needs of the host system.

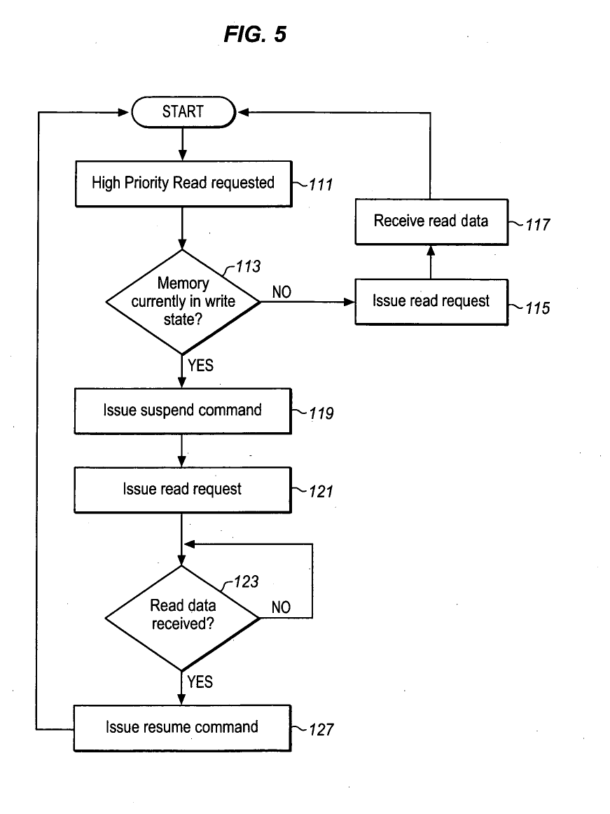

The present invention can also be described using a flow chart as shown with FIG. 5. In FIG. 5, the memory and its host are in operation and the host determines that it requires a high priority read command to be issued to the memory at block 111. First the host determines whether the memory is in a read state at block 113. If it is not, then the operations proceed normally. The host issues the read request at block 115 and then receives the read data at block 117. The process then returns to the start.

If the read request is a low priority read request, the same process can be followed. If the memory is in a write operation and a read request is issued, then the memory will complete the write operation and then service the request. In the e-MMC context of FIG. 1, the memory will transition upon completion of the write operation to the transfer state. It will then respond to the read command and transition to the data state to send the requested data. There is no disruption to any of the operations, however, the response to the read request will be delayed.

If in FIG. 5, the memory is currently in a write state, then the host can issue a suspend command at block 119. This will command the memory to suspend the write operation so that it can response to a read request. The suspend command is followed at block 121 with a read request. At block 123, the host waits until the requested data is received. After it is received, the host then issues a resume command at block 127. This allows the memory to resume the interrupted write operations. The host then returns to the START.

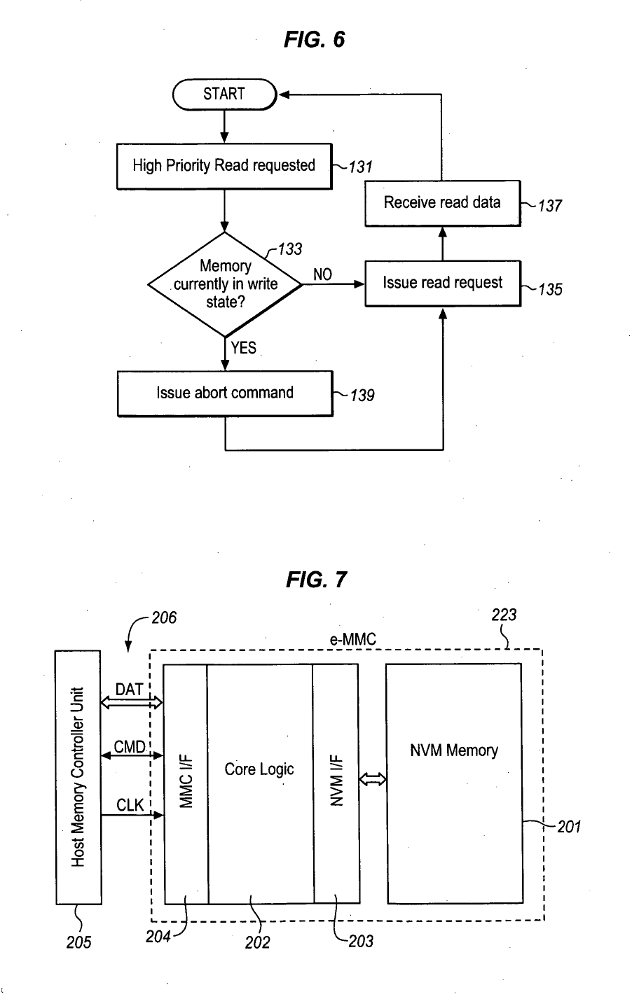

FIG. 6 shows an alternative process flow. As in FIG. 5, the memory and its host are in operation and the host determines that it requires a high priority read command to be issued to the memory at block 131. First the host determines whether the memory is in a read state at block 133. If it is not, then the operations proceed normally. The host issues the read request at block 135 and then receives the read data at block 137. The process then returns to the start. However, if in contrast to FIG. 5, in FIG. 6, if the memory is currently in a write state, then the host issues a stop or abort command at block 139. There is no corresponding resume command for the abort command. The abort command will still command the memory to free itself to respond to a read request. After the abort command the process goes back to block 135. The host issues a read request. The host then receives the data at block 137 and returns to the start. The process flow of FIG. 6 has some optional operations which are not shown. The host can track the last write command that was issued before stop command. After the read data is received the host can then reissue that write command. This will cause the memory to return to a write state and recover any data that was lost when the write process was stopped. Alternatively, the host can wait for an error signal from the memory after the stop command is issued. The error signal can be tracked to the corresponding command and then the corresponding command can be reissued by the host to the memory after the read request has been serviced. In this approach, the memory responds with an error when a write is interrupted by a stop command.

As a further alternative to the flow diagrams of both FIG. 5 and FIG. 6, the operation of determining the state of the memory can be ignored. Typically if a suspend or stop command is issued when the memory is in a standby, or transfer state, then the command will have no effect on the operation of the memory. In some cases, it may result in an error signal, but the host can interpret this as an indication from the memory of its operation state. The system can be configured also so that the suspend or stop command will not be serviced when the memory is in sending data state or a disconnect state as well. This modification simplifies the operations of the host but introduces some uncertainty about the operation of the memory.

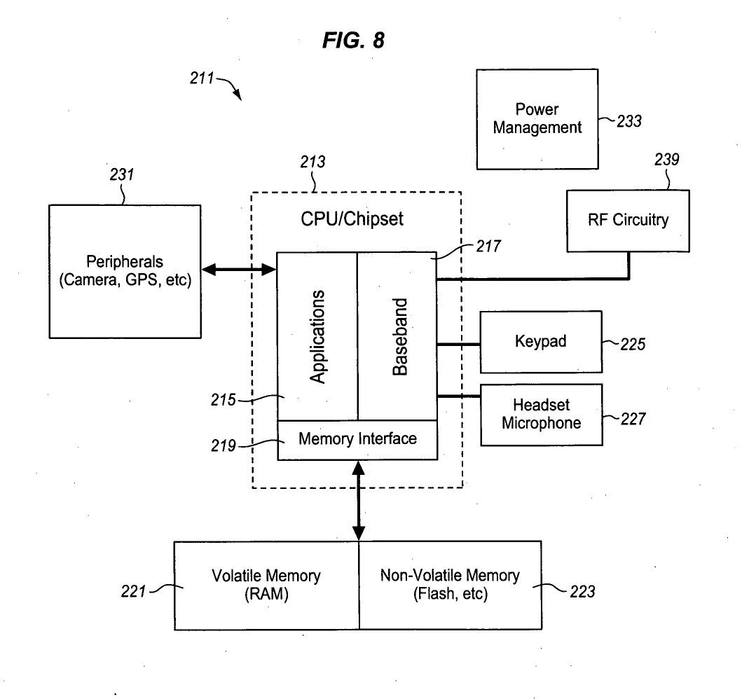

FIG. 7 shows a managed flash memory 223 in the form of an eMMC card. This is just one example of a memory product to which the present invention can be applied. It applies well, however, to the embodiments specifically described above. The illustrated components may be part of single die or composed of several dies. The components may be contained in a single package, housing, or removable card or contained in several discrete packages. The memory card has a non-volatile memory section 201, for example a flash memory, although any other type of memory can be used including volatile memories. The memory can be any of a variety of different sizes, with different partition schemes. In some examples, it will have multiple blocks and each block will have multiple pages. However, other configurations can also be used. The memory is coupled to a memory card controller or core logic 202 through a non-volatile memory interface 203.

The interface typically has a control bus and a data bus to provide a physical layer communication between the controller and the cells of the memory. The controller also has an MMC interface 204 through which the card 223 is coupled to the host's memory controller unit 205. The external MMC interface can have a managed NAND interface to communicate on an MMC, eMMC, UFS, or other NAND based memory interface. This interface has a bus connection 206 to communicate data, commands, and clock timing. However, a different interface adapted to communicate using a different external protocol may be used instead. The memory card controller 202 converts the external interface to the physical interface with the memory 201. The controller or the external MMC interface can include a data buffer to store interim values and accommodate latencies on the internal and external buses. The controller performs a variety of different functions including those discussed above, for example, data processing, memory maintenance, safe management, and error detection and correction.

FIG. 8 shows an example system 211 to which embodiments of the invention may be applied. In the illustrated example, the system is a mobile, handheld, cellular telephone, however, with a few modification, the system may represent a broad range of different devices. The system is driven by a central processing unit (CPU) 213 that may or may not include a chipset. The CPU has an applications section 215 that executes programs using an operating system and a baseband section 217 that handles telephony functions. Both sections are coupled to a memory interface 219 that communicates through a bus with the system's memory.

In the illustrated example, the system memory has a volatile section 221 which may be implemented as random access memory (RAM) for high speed access and a non-volatile section 223, which may be implemented as flash, for data that must survive a power loss. Typically the RAM is used as short term storage for data and instructions that must be accessed quickly, while the flash is used to store operating systems, system parameters and applications. The memory may alternatively be implemented as a single memory entirely in flash and the flash section may be implemented with other types of non-volatile memory, such as PCM (phase change memory), MRM (Magneto Resistive Memory), or FRAM (Ferroelectric Random Access Memory), or some combination of this or any other memory types. The operations described above in the context of FIGS. 5 and 6 are applied to the non-volatile memory. In the event of a power loss, all data stored in the volatile memory will be lost.

The baseband section of the CPU is coupled to a user interface. In the illustrated example, the user interface has a keypad 225 and a headset 227 with a speaker and a microphone. A variety of other interfaces may be used such as a touch screen, Bluetooth devices, accelerometers, proximity sensors, and other interfaces, depending on the particular application. The baseband section is also coupled to RF (Radio Frequency) circuitry 229 to allow the system to communicate with external devices using a radio connection. The radio connection may be a cellular telephone, data, wireless network, or any other interface as desired.

The CPU may also be coupled to any of a variety of peripherals 231, such as cameras, location systems, displays, printers, Bluetooth devices and other peripherals to support any additional functions of the system 211. FIG. 8 also shows a power management system 233 which may include a power supply, such as a battery to regulate the power consumption of the various components. This device may be software driven and controlled by the CPU or autonomous, or a combination of both.

In the description above, many operations are described without specifying which hardware entity performs the operation. Many of these operations can be performed by different hardware units or modules, depending on the particular memory configuration. As mentioned above, for eMMC as presently configured, the host controls reads, writes and logical addresses, while the memory controller maps the logical addresses to physical addresses, performs maintenance, and error detection and correction. Accordingly, the state diagrams refer to the actual state of the memory controller, but that state is determined by commands from the host.

In other systems, the memory is more autonomous, in which case some of the commands described above as being issued by the host will be issued as internal processes of the memory controller. On the other hand, in other system, such as system memory, the host controls every aspect of the memory usage. In this case, the state diagrams refers more correctly to the state of the host in directly controlling the memory. The precise distribution of operations, commands, and responses can be adapted to fit different industry standards and different memory uses. However the present invention is not limited to any particular distribution. The term “computer readable medium” refers to a suitable medium that participates in providing program instructions to a processor, a memory controller or other suitable device for execution. Such a medium may take many forms, including but not limited to, non-volatile media, and volatile media. Non-volatile media may include, for example, optical or magnetic disks, solid state storage and other memory, ROM (Read Only Memory), etc. Volatile media may include dynamic memory, such as system memory, DRAM (Dynamic RAM), SRAM (Static RAM), and other types of volatile storage. Common forms of computer readable media include, for example, magnetic mediums (e.g., floppy disk, flexible disk, hard disk, magnetic tape, and other magnetic mediums), optical mediums (e.g., compact disc read-only memory (CD-ROM) and other optical mediums), physical medium with patterns (e.g., punch cards, paper tape, any other physical mediums), memory chips or cartridges, (e.g., RAM, programmable read-only memory (PROM), erasable programmable read-only memory (EPROM, flash memory, and other memory chips or cartridges), and any other medium from which a computer can read.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a .variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship). Specific embodiments of the present invention have been described above, however, the invention is not limited to the details of such embodiments, but only by the claims below and their reasonable equivalents.

1. A method comprising:
writing a first data set into a memory;
interrupting (119) a second memory write operation; and
reading (121) the first data set from the memory after interrupting the second memory write operation.,

2. The method of claim 1, further comprising resuming (127) the second memory write operation after reading the first set of data.

3. The method of claim 1, further comprising issuing an error signal in response to interrupting the second memory write operation.

4. The method of claim 1, further comprising receiving a command to repeat the interrupted second memory write operation in response to the error signal.

5. The method of claim 1, wherein writing comprises issuing a write command, wherein interrupting comprises issuing an interrupt command, and wherein reading comprises issuing a read command.

6. The method of any one or more of the above claims, wherein interrupting comprises issuing (139) a stop command.

7. The method of any one or more of the above claims, wherein interrupting comprises issuing (119) suspend command.

8. The method of claim 1, wherein interrupting comprises receiving an interrupt command and transitioning from a write state (18) to a send state (12).

9. The method of any one or more of the above claims, wherein the second memory write command comprises a memory maintenance operation such as defragmentation or garbage collection.

10. The method of any one or more of the above claims, wherein reading comprises providing a page of data to a page on demand memory host (205).

11. The method of any one or more of the above claims, wherein the memory is a NAND flash memory (201).

12. An apparatus comprising:
an electronic data memory (201);
a memory controller (202) coupled to the memory; and
a host interface (204) coupled to the memory controller and to a host (205);
wherein the memory controller writes a first data set into the memory, and performs a second memory write operation on the memory, the memory controller receiving a memory read command from the host through the host interface, the memory controller then interrupting the second memory write operation to service the read command.
